(19) United States
(12) Patent Application Publication
(10) Pub. No.: US 2025/0106866 A1
(43) Pub. Date: Mar. 27, 2025

(54) TRANSMISSION OF RADIO RESOURCE CONTROL RECONFIGURATION COMPLETE MESSAGE

(71) Applicant: Apple Inc., Cupertino, CA (US)

(72) Inventors: Kai Zhang, Beijing (CN); Ajay Singh, San Jose, CA (US); Deepankar Bhattacharjee, San Jose, CA (US); Lele Cui, Beijing (CN)

(21) Appl. No.: 18/811,157

(22) Filed: Aug. 21, 2024

Related U.S. Application Data
(60) Provisional application No. 63/540,497, filed on Sep. 26, 2023.

(51) Int. Cl. H04W 72/231; H04L 1/08; H04W 72/1268; H04W 76/20

(52) U.S. Cl. CPC H04W 72/231; H04L 1/08; H04W 72/1268; H04W 76/20

(57) ABSTRACT

Methods, systems, apparatuses, and computer programs for transmission of a radio resource control (RRC) reconfiguration complete message are disclosed. In one aspect, operations are performed by a UE and can include receiving, from a base station, a first downlink control information (DCI) indicating a first uplink grant for a first physical uplink shared channel (PUSCH) transmission, wherein the first DCI includes a redundancy version (RV) corresponding to the first PUSCH transmission; determining whether the RV is self-decodable; and determining whether to transmit a RRC reconfiguration complete message using the first uplink grant for the first PUSCH transmission, based at least in part on the determination of whether the RV is self-decodable.

### CROSS-REFERENCE TO RELATED APPLICATIONS

This application claims priority to U.S. Provisional Application Ser. No. 63/540,497, filed Sep. 26, 2023, entitled “TRANSMISSION OF RADIO RESOURCE CONTROL RECONFIGURATION COMPLETE MESSAGE,” the content of which is hereby incorporated by reference in its entirety.

### BACKGROUND

Wireless communication networks, such as fourth generation (4G), fifth generation (5G), etc., provide integrated communication platforms and telecommunication services to wireless user devices. The wireless communication networks have wireless access nodes that exchange wireless signals with the wireless user devices using wireless network protocols, such as protocols described in various telecommunication standards promulgated by the Third Generation Partnership Project (3GPP). Example wireless communication networks include time-division multiple access (TDMA) networks, frequency-division multiple access (FDMA) networks, orthogonal frequency-division multiple access (OFDMA) networks, Long Term Evolution (LTE), and Fifth Generation New Radio (5G NR).

A user equipment (UE) may use Radio Resource Control (RRC) signaling to establish a communications connection to an access node (e.g., a base station). Alignment at the RRC layer is used for a connection, as it configures parameters across layers, from high layers of Signaling Radio Bearer (SRB)/Data Radio Bearer (DRB) to low layers of Physical Layer (PHY)/Radio Frequency (RF). The RRC signaling refers to the communication protocols and procedures used between the UE and the base station in wireless communication systems. RRC signaling is responsible for managing the radio resources and controlling the connection establishment, maintenance, and release between the UE and the network.

### SUMMARY

According to one innovative aspect of the present disclosure, a method to be performed by user equipment (UE) for transmission of a radio resource control (RRC) reconfiguration complete message is disclosed. In one aspect, the method can include receiving, from a base station, a first downlink control information (DCI) indicating a first uplink grant for a first physical uplink shared channel (PUSCH) transmission, wherein the first DCI includes a redundancy version (RV) corresponding to the first PUSCH transmission; determining whether the RV is self-decodable; and determining whether to transmit a radio resource control (RRC) reconfiguration complete message using the first uplink grant for the first PUSCH transmission, based at least in part on the determination of whether the RV is self-decodable.

Other aspects include UE, apparatuses, systems, and computer programs for performing the aforementioned method.

The innovative method can include other optional features. For example, in some implementations, determining whether the RV is self-decodable comprises: determining that the RV is self-decodable; and determining to transmit the RRC reconfiguration complete message using the first uplink grant for the first PUSCH transmission.

In some implementations, determining whether the RV is self-decodable includes: determining that the RV is not self-decodable; receiving, from the base station, a second DCI indicating a second uplink grant for a second PUSCH transmission; and transmitting the RRC reconfiguration complete message using the second uplink grant for the second PUSCH transmission.

In some implementations, determining whether the RV is self-decodable further includes transmitting information different from the RRC reconfiguration complete message using the first uplink grant for the first PUSCH transmission.

In some implementations, the method further includes: prior to receiving the first DCI indicating the first uplink grant for the first PUSCH transmission, receiving, from the base station, a DCI indicating an uplink grant for PUSCH transmission; and suspending the PUSCH transmission corresponding to the DCI.

In some implementations, the RRC reconfiguration complete message is generated in response to RRC reconfiguration information for a communications connection received from the base station.

In some implementations, the method further including: terminating a communications connection to the base station; receiving, from a new base station, new RRC reconfiguration information for a new communication connection; receiving, from the new base station, a new DCI indicating a new uplink grant for a new PUSCH transmission; suspending the new PUSCH transmission corresponding to the new DCI; during the suspension, configuring new RRC configuration for the new communications connection based at least on the new RRC reconfiguration information; receiving, from the new base station, a first new DCI indicating a first new uplink grant for a first new PUSCH transmission, wherein the first new DCI includes a new RV corresponding to the first new PUSCH transmission; determining whether the new RV is self-decodable; and determining whether to transmit a new RRC reconfiguration complete message using the first new uplink grant for the first new PUSCH transmission, based at least in part on the determination of the new RV.

In some implementations, the RV includes one of RV 1 or RV 2, and the second DCI includes a second RV and the second RV includes one of RV 0 or RV 3.

In some implementations, the first DCI includes a duration between receiving the first DCI and the first PUSCH transmission.

In some implementations, a format of each DCI includes one of DCI format 0_0 or DCI format 0_1.

According to another innovative aspect of the present disclosure, a method to be performed by a base station for transmission of an RRC reconfiguration complete message is disclosed. In one aspect, the method can include transmitting, to a user equipment (UE), a first downlink control information (DCI) indicating a first uplink grant for transmission of a first physical uplink shared channel (PUSCH), wherein the first DCI includes a redundancy version (RV) corresponding to transmission of the first PUSCH; transmitting, to the UE, a second DCI indicating a second uplink grant for transmission of a second PUSCH; in response to transmitting the second DCI, receiving, from the UE, the second PUSCH corresponding to the second DCI, wherein the second PUSCH includes an RRC reconfiguration complete message generated in response to RRC reconfiguration information for a communications connection, wherein the RRC reconfiguration complete message is included in the second PUSCH based on the UE determining that the RV is not self-decodable.

Other aspects include base stations, apparatuses, systems, and computer programs for performing the aforementioned method.

The innovative method can include other optional features. For example, in some implementations, the method further includes receiving, from the UE, the first PUSCH corresponding to the first DCI, wherein the first PUSCH includes information different from the RRC reconfiguration complete message.

In some implementations, the method further including: prior to transmitting the first DCI indicating the first uplink grant for transmission of the first PUSCH, transmitting, to the UE, a DCI indicating an uplink grant for transmission of a PUSCH; and detecting a failure to decode the PUSCH corresponding to the DCI.

In some implementations, the RV includes one of RV 1 or RV 2.

In some implementations, the second DCI includes one of RV 0 or RV 3.

In some implementations, a format of each DCI includes one of DCI format 0_0 or DCI format 0_1.

### BRIEF DESCRIPTION OF THE DRAWINGS

FIG. 1 illustrates an example wireless network, according to some implementations.

FIG. 2A illustrates example system frames for an example process of transmitting an RRC Reconfiguration Complete Message, according to some implementations.

FIG. 2B is a flow chart of the example process disclosed with respect to FIG. 2A.

FIG. 2C is a flow chart of another example process of transmitting an RRC Reconfiguration Complete Message, according to some implementations.

FIG. 2D is a flow chart of another example process of transmitting an RRC Reconfiguration Complete Message, according to some implementations.

FIG. 2E is a flow chart of another example process of transmitting an RRC Reconfiguration Complete Message, according to some implementations.

FIG. 3 illustrates another example process of transmitting an RRC Reconfiguration Complete Message, according to some implementations.

FIG. 4 illustrates an example process of transmitting an RRC Reconfiguration Complete Message when RV is not self-decodable, according to some implementations.

FIG. 5 illustrates an example process of transmitting an RRC Reconfiguration Complete Message in a handover procedure, according to some implementations.

FIG. 6 illustrates an example process of transmitting an RRC Reconfiguration Complete Message when RV is self-decodable, according to some implementations.

FIG. 7 illustrates an example process of transmitting an RRC Reconfiguration Complete Message when RV is self-decodable, according to some implementations.

FIG. 8 illustrates another example process of transmitting an RRC Reconfiguration Complete Message in a handover procedure, according to some implementations.

FIG. 9 is a block diagram of an example UE, according to some implementations.

FIG. 10 is a block diagram of an example access node, according to some implementations.

FIG. 11 is a block diagram of an example apparatus, according to some implementations.

Like reference symbols in the various drawings indicate like elements.

### DETAILED DESCRIPTION

This disclosure describes methods and systems for transmission of a Radio Resource Control (RRC) reconfiguration complete message, allowing the selection of a target Physical Uplink Shared Channel (PUSCH) for the RRC reconfiguration complete message based on redundancy version (RV). In these methods and systems, a user equipment (UE) receives an RRC reconfiguration message for establishing a communications connection from a base station. Upon establishment of the RRC configuration at the UE, the target PUSCH with an RRC reconfiguration complete message is to be transmitted to the base station. In some implementations, the UE can check the value of an RV included in a downlink control information (DCI) scheduling a first PUSCH. The RV value is indicated by 2 bits in the DCI, and it indicates a level of error correction redundancy applied to transport blocks (TB) corresponding to the PUSCH scheduled by the DCI. If the RV is self-decodable, the first PUSCH is selected as the target PUSCH. If the RV is not self-decodable, prior to transmission of the first PUSCH, the UE monitors a communications channel for any new DCI scheduling a new PUSCH. In this context, self-decodability refers to an attribute that the base station is able to decode a PUSCH based on a single transmission, without combining this single transmission with other transmissions. RV is indicated by 2 bits in the DCI, and can have values 0, 1, 2, or 3. Transmissions (e.g., PUSCH) in NR with RV values of 0 or 3 (RV 0 or RV 3) are self-decodable, because these transmissions include sufficient redundancy or error correction coding to allow for independent decoding. Transmissions with other RV values (RV 1 and RV 2) are usually not self-decodable (except at very low code rates), because these transmissions do not include sufficient redundancy or error correction coding for independent decoding, such that the base station relies on additional transmissions to decode a PUSCH by combining with these other transmissions. If there is a new DCI available prior to transmission of the first PUSCH, the new PUSCH is selected as the target PUSCH. However, if there is no new DCI available prior to transmission of the first PUSCH, the first PUSCH is selected as the target PUSCH. Among other examples, the techniques of the disclosure describe procedures to send the RRC reconfiguration complete message in a target PUSCH that avoids retransmissions, leading to a reduction in the overall delay of completing establishment of the RRC configuration.

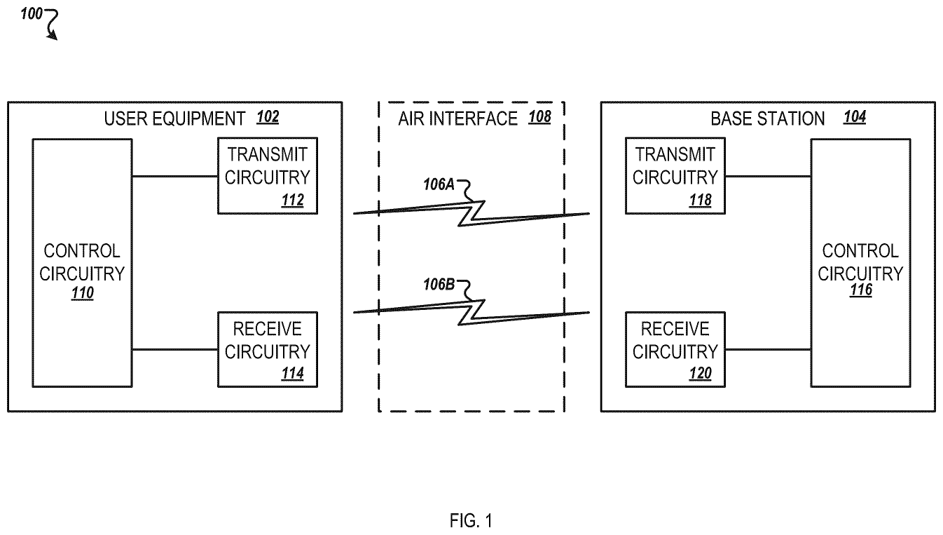

FIG. 1 illustrates an example wireless network, according to some implementations. The wireless network 100 includes a UE 102 and a base station 104 connected via one or more channels 106A, 106B across an air interface 108. The UE 102 and base station 104 communicate using a system that supports controls for managing the access of the UE 102 to a network via the base station 104.

In some implementations, the wireless network 100 may be a Non-Standalone (NSA) network that incorporates Long Term Evolution (LTE) and Fifth Generation (5G) New Radio (NR) communication standards as defined by the Third Generation Partnership Project (3GPP) technical specifications. For example, the wireless network 100 may be an E-UTRA (Evolved Universal Terrestrial Radio Access)—NR Dual Connectivity (EN-DC) network, or an NR-EUTRA Dual Connectivity (NE-DC) network. However, the wireless network 100 may also be a Standalone SA) network that incorporates only 5G NR. Furthermore, other types of communication standards are possible, including future 3GPP systems (e.g., Sixth Generation (6G)) systems, Institute of Electrical and Electronics Engineers (IEEE) 802.11 technology (e.g., IEEE 802.11a; IEEE 802.11b; IEEE 802.11g; IEEE 802.11-2007; IEEE 802.11n; IEEE 802.11-2012; IEEE 802.11ac; or other present or future developed IEEE 802.11 technologies), IEEE 802.16 protocols (e.g., WMAN, WiMAX, etc.), or the like. While aspects may be described herein using terminology commonly associated with 5G NR, aspects of the present disclosure can be applied to other systems, such as 3G, 4G, and/or systems subsequent to 5G (e.g., 6G).

In the wireless network 100, the UE 102 and any other UE in the system may be, for example, laptop computers, smartphones, tablet computers, machine-type devices such as smart meters or specialized devices for healthcare, intelligent transportation systems, or any other wireless devices with or without a user interface. In network 100, base station 104 provides the UE 102 network connectivity to a broader network (not shown). This UE 102 connectivity is provided via the air interface 108 in a base station service area provided by base station 104. In some implementations, such a broader network may be a wide area network operated by a cellular network provider, or may be the Internet. Each base station service area associated with base station 104 is supported by antennas integrated with base station 104. The service areas are divided into a number of sectors associated with certain antennas. Such sectors may be physically associated with fixed antennas or may be assigned to a physical area with tunable antennas or antenna settings adjustable in a beamforming process used to direct a signal to a particular sector.

The UE 102 includes control circuitry 110 coupled with transmit circuitry 112 and receive circuitry 114. The transmit circuitry 112 and receive circuitry 114 may each be coupled with one or more antennas. The control circuitry 110 may include various combinations of application specific circuitry and baseband circuitry. The transmit circuitry 112 and receive circuitry 114 may be adapted to transmit and receive data, respectively, and may include radio frequency (RF) circuitry or front-end module (FEM) circuitry.

In various implementations, aspects of the transmit circuitry 112, receive circuitry 114, and control circuitry 110 may be integrated in various ways to implement the operations described herein. The control circuitry 110 may be adapted or configured to perform various operations such as those described elsewhere in this disclosure related to a UE.

The transmit circuitry 112 can perform various operations described in this specification. Additionally, the transmit circuitry 112 may transmit a plurality of multiplexed uplink physical channels. The plurality of uplink physical channels may be multiplexed according to time division multiplexing (TDM) or frequency division multiplexing (FDM) along with carrier aggregation. The transmit circuitry 112 may be configured to receive block data from the control circuitry 110 for transmission across the air interface 108.

The receive circuitry 114 can perform various operations described in this specification. Additionally, the receive circuitry 114 may receive a plurality of multiplexed downlink physical channels from the air interface 108 and relay the physical channels to the control circuitry 110. The plurality of downlink physical channels may be multiplexed according to TDM or FDM along with carrier aggregation. The transmit circuitry 112 and the receive circuitry 114 may transmit and receive both control data and content data (e.g., messages, images, video, etc.) structured within data blocks that are carried by the physical channels.

FIG. 1 also illustrates the base station 104. In implementations, the base station 104 may be an NG radio access network (RAN) or a 5G RAN, an E-UTRAN, a non-terrestrial cell, or a legacy RAN, such as a UTRAN or GERAN. As used herein, the term “NG RAN” or the like may refer to the base station 104 that operates in an NR or 5G wireless network 100, and the term “EUTRAN” or the like may refer to a base station 104 that operates in an LTE or 4G wireless network 100. The UE 102 utilizes connections (or channels) 106A, 106B, each of which includes a physical communications interface or layer.

The base station 104 circuitry may include control circuitry 116 coupled with transmit circuitry 118 and receive circuitry 120. The transmit circuitry 118 and receive circuitry 120 may each be coupled with one or more antennas that may be used to enable communications via the air interface 108. The transmit circuitry 118 and receive circuitry 120 may be adapted to transmit and receive data, respectively, to any UE connected to the base station 104. The transmit circuitry 118 may transmit downlink physical channels includes of a plurality of downlink subframes. The receive circuitry 120 may receive a plurality of uplink physical channels from various UEs, including the UE 102.

In FIG. 1, the one or more channels 106A, 106B are illustrated as an air interface to enable communicative coupling, and can be consistent with cellular communications protocols, such as a GSM protocol, a CDMA network protocol, a UMTS protocol, a 3GPP LTE protocol, an Advanced long term evolution (LTE-A) protocol, a LTE-based access to unlicensed spectrum (LTE-U), a 5G protocol, an NR protocol, an NR-based access to unlicensed spectrum (NR-U) protocol, and/or any of the other communications protocols discussed herein. In implementations, the UE 102 may directly exchange communication data via a ProSe interface. The ProSe interface may alternatively be referred to as a sidelink (SL) interface and may include one or more logical channels, including but not limited to a Physical Sidelink Control Channel (PSCCH), a Physical Sidelink Control Channel (PSCCH), a Physical Sidelink Discovery Channel (PSDCH), and a Physical Sidelink Broadcast Channel (PSBCH).

### RRC Signaling Procedure

A UE (e.g., the UE 102 of FIG. 1) communicates with an access node (e.g., a base station 104 of FIG. 1) using RRC signaling to establish a communications connection. The RRC signaling procedure involves the UE receiving an RRC reconfiguration message (or RRC reconfiguration information) from the base station, validating/applying parameters included in the RRC reconfiguration message locally at the UE, and sending an RRC reconfiguration complete message back to the base station, indicating that the RRC configuration has been established at UE. The RRC signaling procedure can be used for the initial RRC connection setup and update of the RRC connection.

In some cases, during the RRC signaling procedure, processing of physical layer channels, like Physical Uplink Shared Channel (PUSCH)/Physical Downlink Control Channel (PDCCH), are suspended at the UE for a period of time due to local UE adaptation of refreshed configurations from an RRC reconfiguration message. For example, the suspension can occur between UE receiving an uplink grant from a base station and UE transmitting a reconfiguration complete message to the base station. In some cases, the suspension includes UE skipping a PUSCH that is scheduled during the adaptation period by an uplink grant (UL grant) specified by a downlink control information (DCI). In some cases, the suspension includes the UE missing DCIs for the UL grant due to the shutdown of PDCCH, and accordingly failing to know scheduling of PUSCH.

After completing the local RRC configuration, the UE transmits an RRC reconfiguration complete message to the base station. In some cases, this RRC reconfiguration complete message can be included in the PUSCH after the UE recovers its physical layer channels from suspension. However, since the base station fails to decode (e.g., receive) the skipped PUSCH during the suspension period, the base station's hybrid automatic repeat request (HARQ) mechanism requests retransmission of the skipped PUSCH. In some cases, the UE includes the RRC complete message into a retransmitted PUSCH.

### Uplink HARQ Transmission Mechanism

DCI format 0_0 or 0_1 is used for PUSCH scheduling, and the base station specifies a redundancy version (RV) in the DCI payload. As noted previously, the value of the RV indicates a level of error correction redundancy applied to the transport blocks (TB) corresponding to the PUSCH scheduled by the DCI. The RV is a selection of bits from the same TB based on specification defined rules. Not all RVs can be self-decodable without the HARQ combination. DCI format 0_0 is used when only one UE is scheduled for uplink transmission. DCI format 0_1 is used when multiple UEs, associated with the same DCI message, are scheduled for uplink transmission.

The duration between DCI and corresponding PUSCH can be included as a K2 field in the DCI payload, and the value of duration refers to a lookup table defined in the RRC configuration. The unit of duration can be milliseconds, seconds, slots in a subframe, or the like. The duration between the first PUSCH and the subsequent retransmission (RETX) is dynamic, and the base station is flexible in scheduling. The K2 field can also carry additional control information or parameters related to downlink transmission.

Transmission of RRC Reconfiguration Complete Message based on RV of PUSCH

The RRC reconfiguration complete message is transmitted to the base station, confirming configuration establishment at UE. The payload size of the RRC reconfiguration complete message is small (usually less than 10 bytes), and it is sensitive to latency. Existing RRC signaling procedures do not check the value of the RV when including the RRC reconfiguration completion message into a PUSCH, such that the UE may transmit an RRC reconfiguration complete message in response to a DCI with an RV that is not self-decodable. This can lead to the base station receiving a PUSCH with an RRC reconfiguration complete message that the base station cannot decode, causing the base station to send additional DCIs for retransmission of the PUSCH. The net result is that the UE retransmits the PUSCH with the RRC reconfiguration complete message multiple times, increasing the overall delay in completing establishment of the RRC connection.

The disclosed implementations describe procedures to send the RRC reconfiguration complete message in a PUSCH that avoids retransmissions, leading to a reduction in the overall delay of completing establishment of the RRC configuration.

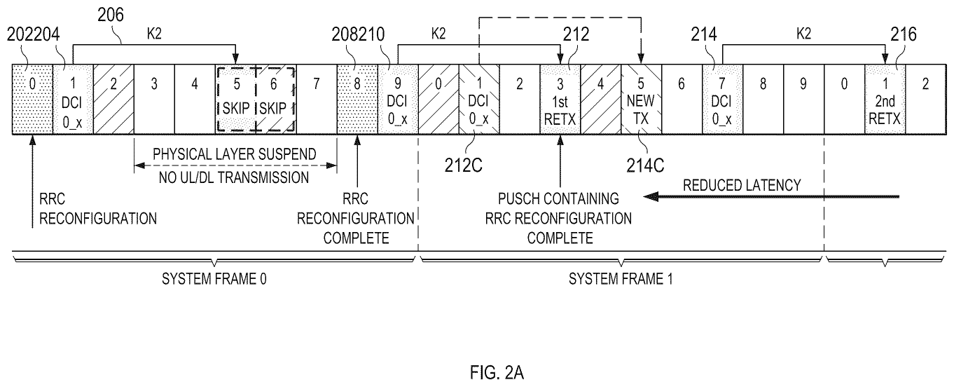

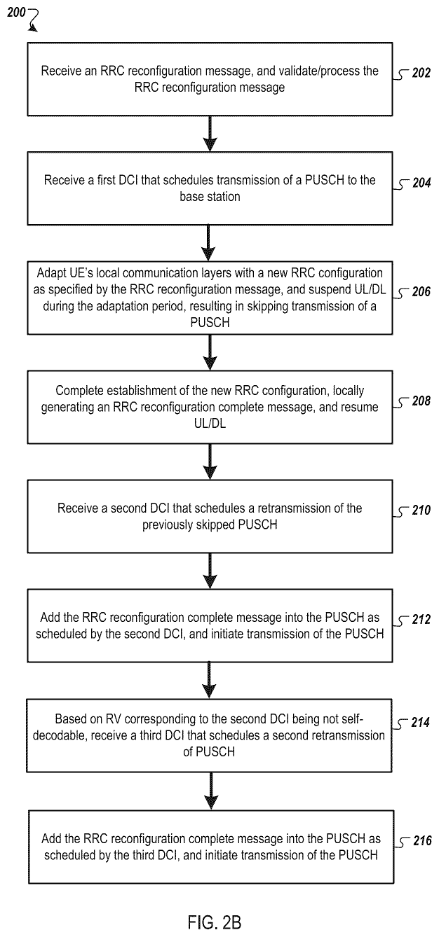

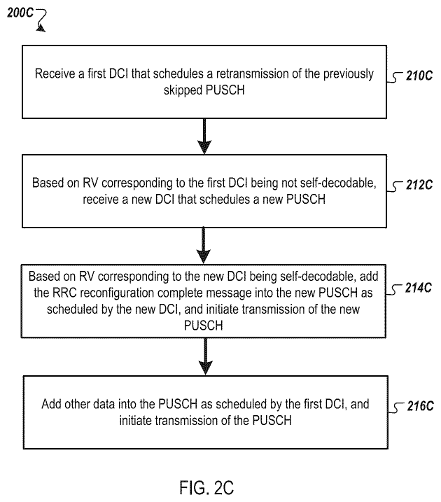

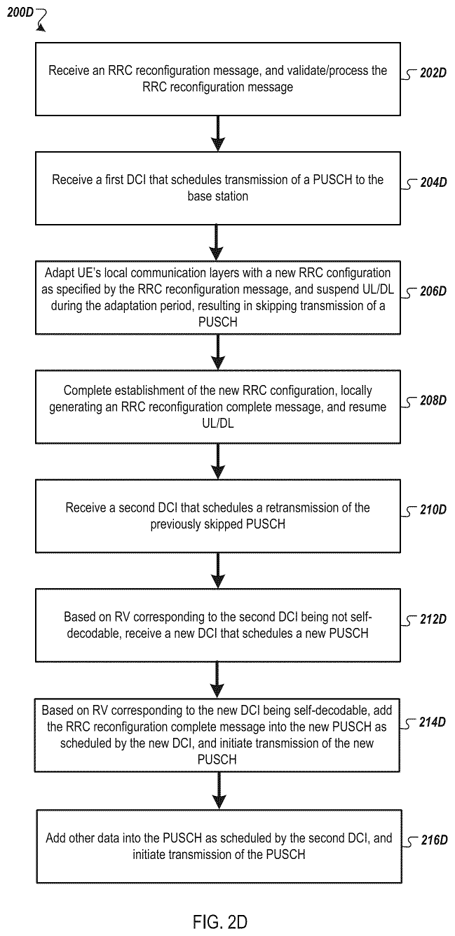

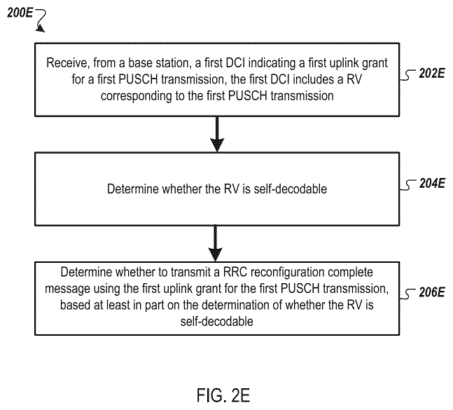

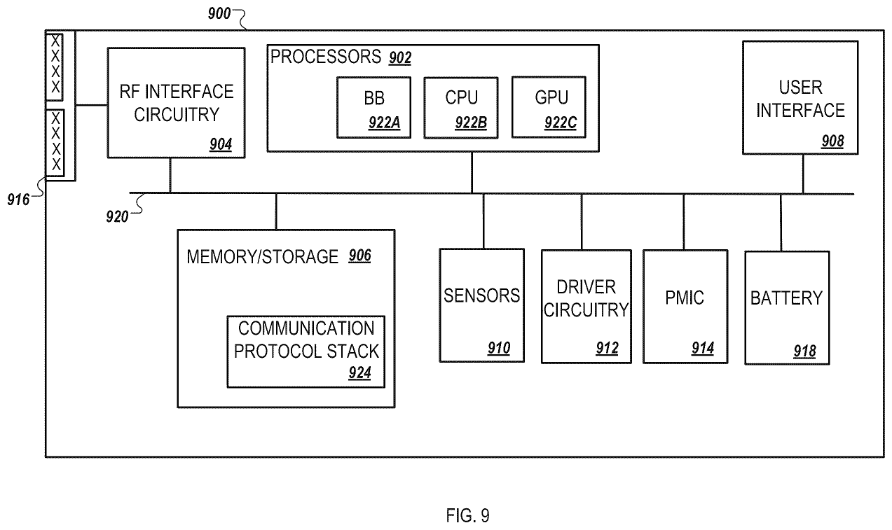

FIG. 2A illustrates example system frames for an example process of transmitting an RRC Reconfiguration Complete Message, according to some implementations. FIG. 2B is a flow chart of example process 200 disclosed with respect to FIG. 2A. The process 200 is described as being performed by a UE such as UE 102 of FIG. 1 or UE 900 of FIG. 9, in some implementations.

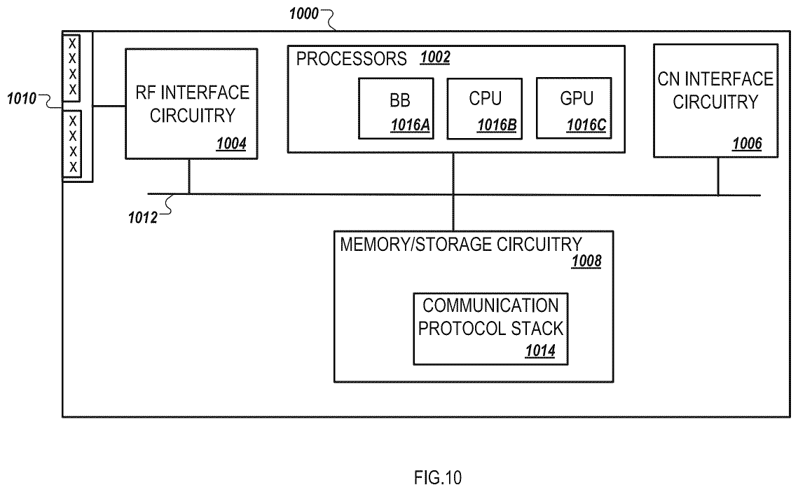

Referring to FIGS. 2A and 2B, in one example process 200, the system frame/slot is referred to as X/Y (X^{th} frame and Y^{th} slot). The duration of a slot depends on configuration of a frame structure. For example, in Frequency Division Duplex (FDD) mode, a slot can be 1 millisecond, while in Time Division Duplex (TDD) mode, a slot can be 0.5 milliseconds. Each frame can include multiple slots, e.g., ten slots. At 202, in a first system frame (system frame 0), a UE (e.g., UE 102 of FIG. 1 or UE 900 of FIG. 9) receives an RRC reconfiguration message from a base station (e.g., base station 104 of FIG. 1 or base station 1000 of FIG. 10) at 0/0 (system frame 0/slot 0) and starts to validate/process the RRC reconfiguration message. At 204, The UE receives a first DCI (e.g., DCI 0_0 or DCI 0_1) including uplink grant at 0/1 (system frame 0/slot 0), which schedules transmission of a PUSCH to the base station at 0/5 (system frame 0/slot 5, K2 slots later). At 206, the UE adapts its local communication layers with a new RRC configuration as specified by the RRC reconfiguration message, suspending Uplink (UL)/Downlink (DL) during the adaptation period from 0/3 (system frame 0/slot 3) to 0/7 (system frame 0/slot 7), and thus the scheduled PUSCH at 0/5 (system frame 0/slot 5) is skipped. At 208, the UE completes the establishment of the new RRC configuration, locally generates an RRC reconfiguration complete message, and resumes UL/DL at 0/8 (system frame 0/slot 8). However, due to the earlier UL/DL suspension, no immediate UL resource is available for transmitting a PUSCH including the RRC reconfiguration complete message. At 210, the UE receives another DCI at 0/9 (system frame 0/slot 9), which schedules a PUSCH at 1/3 (system frame 1/slot 3), which is retransmission of previously skipped PUSCH at 0/5 (system frame 0/slot 5). At 212, Without checking the RV corresponding to the DCI (e.g., the DCI includes a bit field indicating the RV) at 0/9 (system frame 0/slot 9), the UE adds the RRC reconfiguration complete message into the PUSCH that is transmitted at 1/3 (system frame 1/slot 3). If the RV is not RV0 or RV3, there would be a base station decoding failure at the base station to decode the RRC reconfiguration complete message received in the PUSCH at 1/3 (system frame 1/slot 3). At 214, the decoding failure causes the base station to send another DCI at 1/7 (system frame 1/slot 7), requesting a retransmission of the PUSCH using the same HARQ ID. At 216, in response to the DCI at 1/7 (system frame 1/slot 7), the UE performs the second retransmission of the PUSCH at 2/1 (system frame 2/slot 1). In some implementations, the base station can decode the reconfiguration complete message correctly by combining the PUSCHs at 1/3 (system frame 1/slot 3)+2/1 (system frame 2/slot 1). In some implementations, the base station still fails to decode the reconfiguration complete message by combined PUSCHs at 1/3 (system frame 1/slot 3)+2/1 (system frame 2/slot 1), and one or more additional retransmissions are requested.

FIG. 2C is a flow chart of another example process 200C of transmitting an RRC Reconfiguration Complete Message, according to some implementations. The process 200C is described as being performed by a UE such as UE 102 of FIG. 1 or UE 900 of FIG. 9, in some implementations.

Referring to FIGS. 2A and 2C, the UE performs a modified RRC signaling process 200C that reduces the number of transmissions. Block 210C is the same as the block 210 of FIG. 2B. At 212C, the UE checks the RV corresponding to the DCI at 0/9, and determines that the RV value is 1 or 2 (RV is not self-decodable). Following such determination, the UE monitors a communications channel (e.g., L1/L2 control channels) for any new DCI from the base station between the time of the DCI at 0/9 and the scheduled time of retransmission of the PUSCH at 1/3. The UE receives a new DCI at 1/1 that schedules a new PUSCH at 1/5. At 214C, the UE checks the RV value for the new DCI; if the RV is a self-decodable RV (e.g., RV value 0 or 3), then the UE adds the RRC reconfiguration complete message into the new PUSCH that is transmitted at 1/5. At 216C, to avoid resource waste, the UE adds other data into the PUSCH that is transmitted at 1/3. The other data can be any data, except for the RRC reconfiguration complete message. Although the initial transmission time for the RRC reconfiguration complete message is delayed by two slots (compared to retransmission at 1/3), the new PUSCH at 1/5 can be decoded successfully by the base station, such that there is no additional retransmission of the RRC reconfiguration complete message. Thus, the overall latency is reduced. If there is no new DCI received between the time of the DCI at 0/9 and the scheduled time of retransmission of the PUSCH at 1/3, the UE performs retransmission at 1/3, which is the same as block 212.

FIG. 2D is a flow chart of another example process 200D of transmitting an RRC Reconfiguration Complete Message, according to some implementations. The process 200D is described as being performed by a UE such as UE 102 of FIG. 1 or UE 900 of FIG. 9, in some implementations.

Referring to FIGS. 2A and 2D, the UE performs a modified RRC signaling process 200D that reduces the number of transmissions. Blocks 202D to 210D are the same as the blocks 202 to 210 of FIG. 2B. At 212D, the UE checks the RV corresponding to the DCI at 0/9, and determines that the RV value is 1 or 2 (RV is not self-decodable). Following such determination, the UE monitors a communications channel (e.g., L1/L2 control channels) for any new DCI from the base station between the time of the DCI at 0/9 and the scheduled time of retransmission of the PUSCH at 1/3. The UE receives a new DCI at 1/1 that schedules a new PUSCH at 1/5. At 214D, the UE checks the RV value for the new DCI; if the RV is a self-decodable RV (e.g., RV value 0 or 3), then the UE adds the RRC reconfiguration complete message into the new PUSCH that is transmitted at 1/5. At 216D, to avoid resource waste, the UE adds other data into the PUSCH that is transmitted at 1/3. The other data can be any data, except for the RRC reconfiguration complete message. Although the initial transmission time for the RRC reconfiguration complete message is delayed by two slots (compared to retransmission at 1/3, the new PUSCH at 1/5 can be decoded successfully by the base station, such that there is no additional retransmission of the RRC reconfiguration complete message. Thus, the overall latency is reduced. If there is no new DCI received between the time of the DCI at 0/9 and the scheduled time of retransmission of the PUSCH at 1/3, the UE performs retransmission at 1/3, which is the same as block 212.

FIG. 2E is a flow chart of another example process 200E of transmitting an RRC Reconfiguration Complete Message, according to some implementations. The process 200E is described as being performed by a UE such as UE 102 of FIG. 1 or UE 900 of FIG. 9, in some implementations.

At 202E, the UE receives a first DCI indicating a first uplink grant for a first PUSCH transmission from the base station. The first DCI includes an RV corresponding to the first PUSCH transmission. At 204E, the UE determines whether the RV is self-decodable. At 206E, the UE determines whether to transmit an RRC reconfiguration complete message using the first uplink grant for the first PUSCH transmission, based at least in part on the determination of whether the RV is self-decodable.

If determination is that the RV is self-decodable, then the UE transmits the RRC reconfiguration complete message using the first uplink grant for the first PUSCH transmission. For example, the UE adds the RRC complete message into the first PUSCH and transmits the first PUSCH including the RRC complete message to the base station.

If determination is that the RV is not self-decodable, the UE receives a second DCI indicating a second uplink grant for a second PUSCH transmission from the base station. The UE transmits the RRC reconfiguration complete message using the second uplink grant for the second PUSCH transmission. The UE transmits information different from the RRC reconfiguration complete message using the first uplink grant for the first PUSCH transmission. For example, the UE adds the RRC complete message into the second PUSCH and transmits the second PUSCH including the RRC complete message to the base station. The UE adds information different from the RRC reconfiguration complete message into the first PUSCH and transmits the first PUSCH including the RRC complete message to the base station.

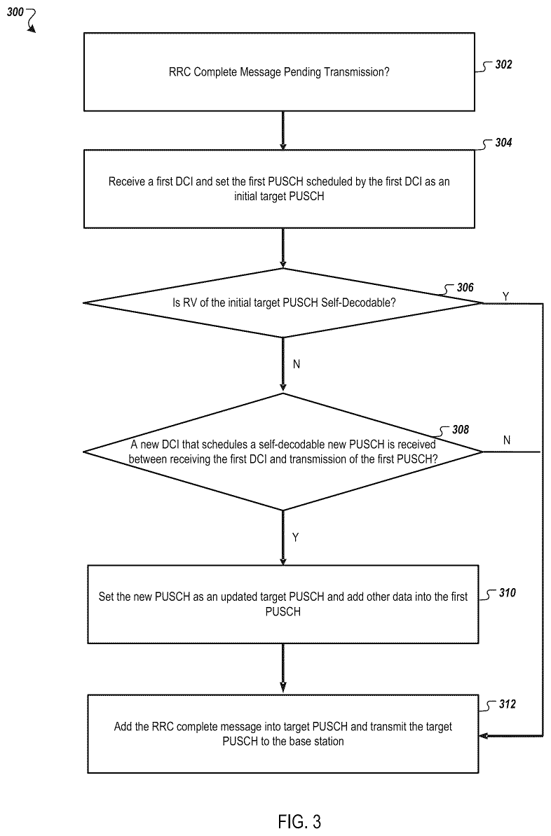

FIG. 3 illustrates another example process 300 of transmitting an RRC Reconfiguration Complete Message, according to some implementations. The process 300 is described as being performed by a UE such as UE 102 of FIG. 1 or UE 900 of FIG. 9, in some implementations.

At 302, the UE determines that there is an RRC complete message generated and pending transmission. At 304, the UE sets the first available PUSCH (as scheduled by the first DCI) for first retransmission as an initial target PUSCH. At 306, the UE checks if the RV of the PUSCH is self-decodable. If the RV of the PUSCH is self-decodable, the UE proceeds to perform block 312. If the RV of the PUSCH is not self-decodable, the selection mechanism kicks in. At 308, the UE checks if a new DCI corresponding to a self-decodable new PUSCH occurs in the duration between receiving the first available DCI and its corresponding first retransmission. If no new DCI occurs in between, the UE proceeds to perform block 312. If a new DCI occurs in between, at 310, the UE sets the new PUSCH as an updated target PUSCH and adds other data into the previous target PUSCH to avoid resource waste. At 312, the UE adds the RRC complete message into the target PUSCH and transmits the target PUSCH including the RRC complete message to the base station.

Techniques of the disclosure provide a mechanism for selecting a target PUSCH based on the RV value to transmit an RRC reconfiguration complete message. Advantages of the disclosed techniques include transmitting a new PUSCH to reduce latency caused by retransmission of PUSCH due to non-decodable RV, while providing a fallback if there is no new PUSCH available.

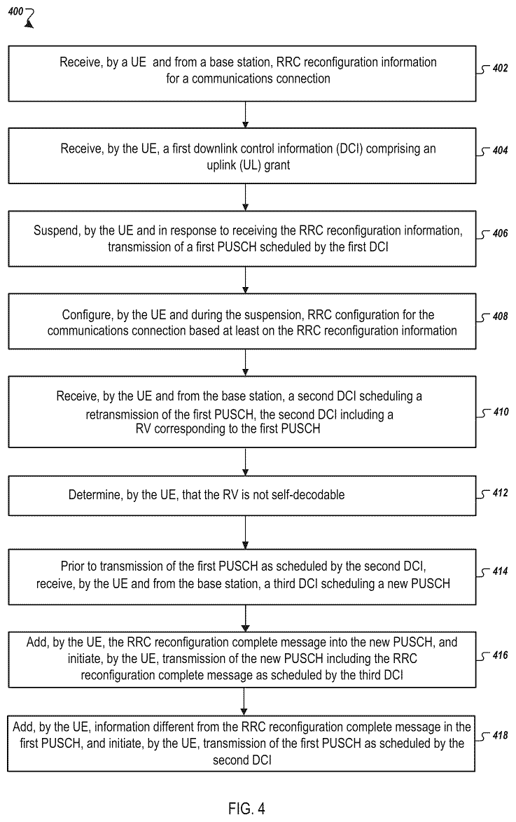

FIG. 4 illustrates an example process of transmitting an RRC Reconfiguration Complete Message when RV is not self-decodable, according to some implementations. The process 400 is described as being performed by a UE such as UE 102 of FIG. 1 or UE 900 of FIG. 9, in some implementations.

In the process 400, at 402, the UE receives, from a base station, RRC reconfiguration information for a communications connection. RRC reconfiguration information refers to a set of parameters and configuration updates that are exchanged between the base station (such as base station 104 of FIG. 1 or base station 1000 of FIG. 10) and the UE during an RRC reconfiguration process in wireless communication systems. RRC reconfiguration is a process that allows the base station to modify or update the configuration of an established RRC connection with the UE. This can include changes to radio resource allocation, mobility-related parameters, handover settings, security parameters, and other network-specific configuration updates.

At 404, the UE receives a first DCI including an uplink (UL) grant. The uplink grant refers to the allocation of resources and permission given by the base station, to a UE for transmitting data on the uplink channel. The uplink grant specifies the resources, such as time slots, frequency bands, and modulation schemes, that the UE can utilize for transmitting its data to the base station.

At 406, in response to receiving the RRC reconfiguration information, the UE suspends transmission of a first PUSCH scheduled by the first DCI. The UE suspends transmission of the first PUSCH for a period of time due to local UE adaptation of refreshed configurations from the RRC reconfiguration message. The transmission of the first PUSCH is skipped during the suspension.

At 408, during the suspension, the UE adapts RRC configuration for the communications connection based at least on the RRC reconfiguration information.

At 410, the UE receives, from the base station, a second DCI scheduling a retransmission of the first PUSCH. The second DCI includes an RV value corresponding to the first PUSCH. For example, the RV value is RV 1 or RV 2 indicating that the RV is not self-decodable.

At 412, the UE determines that the RV is not self-decodable. The UE identifies that the RV value is RV 1 or RV 2.

At 414, prior to transmission of the first PUSCH as scheduled by the second DCI, the UE receives, from the base station, a third DCI scheduling a new PUSCH. The UE receives the third DCI in the duration between receiving the second DCI and transmission of the first PUSCH.

At 416, upon receiving the third DCI and in response to determining that the RV is not self-decodable, the UE adds the RRC reconfiguration complete message into the new PUSCH, and initiates transmission of the new PUSCH including the RRC reconfiguration complete message as scheduled by the third DC.

At 418, the UE adds other data (e.g., information different from the RRC reconfiguration complete message) into the first PUSCH; and initiates transmission of the first PUSCH as scheduled by the second DCI.

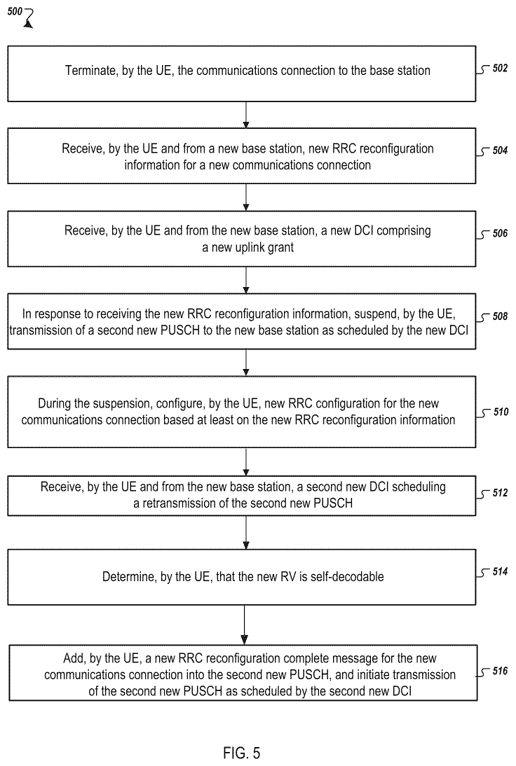

FIG. 5 illustrates an example process of transmitting an RRC Reconfiguration Complete Message in a handover procedure, according to some implementations. The process 500 is described as being performed by a UE such as UE 102 of FIG. 1 or UE 900 of FIG. 9, in some implementations.

In the process 500, at 502, the UE terminates the communications connection to the current base station. As UE moves, the network initiates a handover when it determines that the signal from the current base station is weakening or degrading. The UE terminates the communications connection to the current base station, and is ready for establishing a communications connection to a new base station. Handover, also known as handoff, is a process in cellular networks where an ongoing call or data session is seamlessly transferred from one base station to another as a user moves through the coverage area. The purpose of the handover is to maintain the continuity of the communication session without interruption or loss of quality.

At 504, the UE receives, from a new base station, new RRC reconfiguration information for a new communications connection.

At 506, the UE receives a new DCI including a new uplink grant.

At 508, in response to receiving the new RRC reconfiguration information, the UE suspends transmission of a second new PUSCH to the new base station as scheduled by the new DCI.

At 510, during the suspension, the UE configures a new RRC configuration for the new communications connection based at least on the new RRC reconfiguration information.

At 512, the UE receives, from the new base station, a second new DCI scheduling a retransmission of the second new PUSCH. The second new DCI includes a new RV corresponding to the second new PUSCH.

At 514, the UE determines that the new RV is self-decodable. The UE identifies that the new RV value is RV 0 or RV 3.

At 516, upon receiving the second new DCI and in response to determining that the RV is self-decodable, the UE adds a new RRC reconfiguration complete message for the new communications connection into the second new PUSCH and initiates transmission of the second new PUSCH as scheduled by the second new DCI.

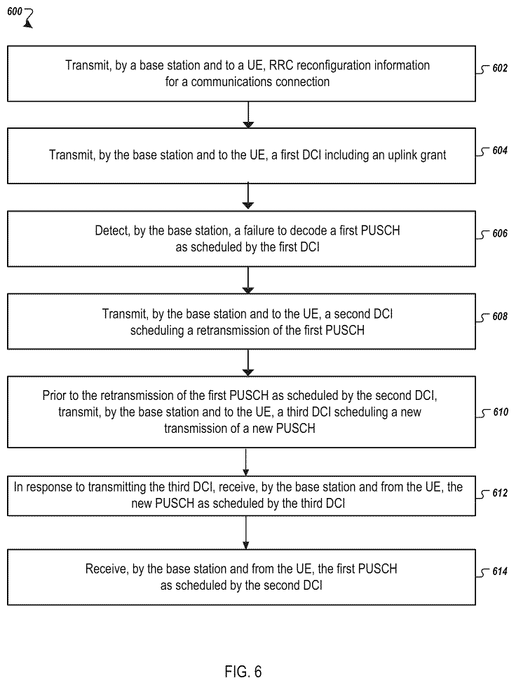

FIG. 6 illustrates an example process of transmitting an RRC Reconfiguration Complete Message when RV is self-decodable, according to some implementations. The process 600 is described as being performed by a base station such as base station 104 of FIG. 1 or base station 1000 of FIG. 10, in some implementations.

In the process 600, at 602, the base station transmits RRC reconfiguration information for a communications connection to a UE.

At 604, the base station transmits a first DCI including an uplink grant to the UE.

At 606, the base station detects a failure to decode a first PUSCH as scheduled by the first DCI, because no first PUSCH is received due to suspension at UE. The suspension takes place during the adaptation period of refreshed configurations from an RRC reconfiguration message.

At 608, the base station transmits a second DCI scheduling a retransmission of the first PUSCH. The second DCI includes a redundancy version (RV) corresponding to the first PUSCH.

At 610, based on the RV being not self-decodable, prior to the retransmission of the first PUSCH as scheduled by the second DCI, the base station transmits a third DCI scheduling a new transmission of a new PUSCH to the UE.

At 612, in response to transmitting the third DCI, the base station receives the new PUSCH as scheduled by the third DCI from the UE. The new PUSCH includes the RRC reconfiguration complete message.

At 614, the base station also receives the first PUSCH as scheduled by the second DCI. The first PUSCH includes other data (e.g., information different from the RRC reconfiguration complete message) to avoid resource waste.

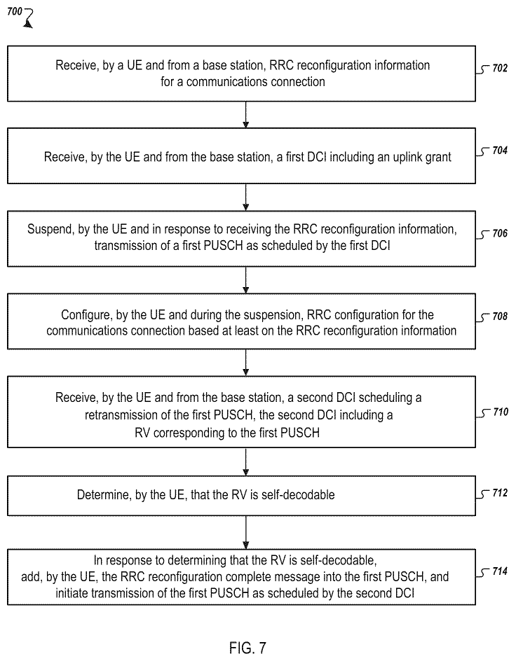

FIG. 7 illustrates an example process of transmitting an RRC Reconfiguration Complete Message when RV is self-decodable, according to some implementations. The process 700 is described as being performed by a UE, such as UE 102 of FIG. 1 or UE 900 of FIG. 9, in some implementations.

In the process 700, at 702, the UE receives RRC reconfiguration information for a communications connection from a base station.

At 704, the UE receives a first DCI including an uplink grant.

At 706, in response to receiving the RRC reconfiguration information, the UE suspends transmission of a first PUSCH as scheduled by the first DCI.

At 708, the UE configures, during the suspension, the RRC configuration for the communications connection based at least on the RRC reconfiguration information.

At 710, the UE receives a second DCI scheduling a retransmission of the first PUSCH from the base station. The second DCI includes an RV corresponding to the first PUSCH.

At 712, the UE determines that the RV is self-decodable. The UE identifies that the RV value is RV 0 or RV 3.

At 714, in response to determining that the RV is self-decodable, the UE adds the RRC reconfiguration complete message into the first PUSCH and initiates transmission of the first PUSCH as scheduled by the second DCI.

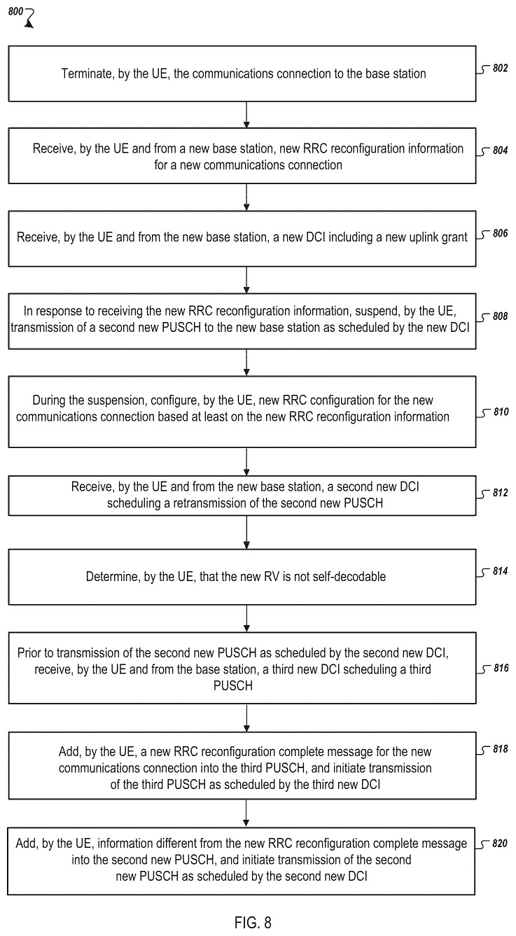

FIG. 8 illustrates another example process of transmitting an RRC Reconfiguration Complete Message in a handover procedure, according to some implementations. The process 800 is described as being performed by a UE such as UE 102 of FIG. 1 or UE 900 of FIG. 9, in some implementations.

In the process 800, at 802, the UE terminates the communications connection to the base station.

At 804, the UE receives, from a new base station, new RRC reconfiguration information for a new communications connection.

At 806, the UE receives, from the new base station, a new DCI comprising a new uplink grant.

At 808, in response to receiving the new RRC reconfiguration information, the UE suspends transmission of a second new PUSCH to the new base station as scheduled by the new DCI.

At 810, during the suspension, the UE configures a new RRC configuration for the new communications connection based at least on the new RRC reconfiguration information.

At 812, the UE receives, from the new base station, a second new DCI scheduling a retransmission of the second new PUSCH. The second new DCI includes a new RV corresponding to the second new PUSCH.

At 814, the UE determines that the new RV is not self-decodable. The UE identifies that the new RV value is RV 1 or RV 2.

At 816, prior to transmission of the second new PUSCH as scheduled by the second new DCI, the UE receives a third new DCI scheduling a third PUSCH from the base station.

At 818, upon receiving the third new DCI and in response to determining that the new RV is not self-decodable, the UE adds a new RRC reconfiguration complete message for the new communications connection into the third PUSCH, and initiates transmission of the third PUSCH as scheduled by the third new DCI.

At 820, the UE adds other data (e.g., information different from the new RRC reconfiguration complete message) into the second new PUSCH, and initiates transmission of the second new PUSCH as scheduled by the second new DCI.

FIG. 9 is a block diagram of an example UE, according to some implementations. The UE 900 may be similar to and substantially interchangeable with UE 102 of FIG. 1.

The UE 900 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices (for example, a smartwatch), relaxed-IoT devices.

The UE 900 may include processors 902, RF interface circuitry 904, memory/storage 906, user interface 908, sensors 910, driver circuitry 912, power management integrated circuit (PMIC) 914, antenna structure 916, and battery 918. The components of the UE 900 may be implemented as integrated circuits (ICs), portions thereof, discrete electronic devices, or other modules, logic, hardware, software, firmware, or a combination thereof. The block diagram of FIG. 9 is intended to show a high-level view of some of the components of the UE 900. However, some of the components shown may be omitted, additional components may be present, and different arrangements of the components shown may occur in other implementations.

The components of the UE 900 may be coupled with various other components over one or more interconnects 920, which may represent any type of interface, input/output, bus (local, system, or expansion), transmission line, trace, optical connection, etc. that allows various circuit components (on common or different chips or chipsets) to interact with one another.

The processors 902 may include processor circuitry such as, for example, baseband processor circuitry (BB) 922A, central processor unit circuitry (CPU) 922B, and graphics processor unit circuitry (GPU) 922C. The processors 902 may include any type of circuitry or processor circuitry that executes or otherwise operates computer-executable instructions, such as program code, software modules, or functional processes from memory/storage 906 to cause the UE 900 to perform operations as described herein.

In some implementations, the baseband processor circuitry 922A may access a communication protocol stack 924 in the memory/storage 906 to communicate over a 3GPP compatible network. In general, the baseband processor circuitry 922A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum layer. In some implementations, the PHY layer operations may additionally/alternatively be performed by the components of the RF interface circuitry 904. The baseband processor circuitry 922A may generate or process baseband signals or waveforms that carry information in 3GPP-compatible networks. In some implementations, the waveforms for NR may be based on cyclic prefix OFDM “CP-OFDM” in the uplink or downlink, and discrete Fourier transform spread OFDM “DFT-S-OFDM” in the uplink.

The memory/storage 906 may include one or more non-transitory, computer-readable media that includes instructions (for example, communication protocol stack 924) that may be executed by one or more of the processors 902 to cause the UE 900 to perform various operations described herein. The memory/storage 906 includes any type of volatile or non-volatile memory that may be distributed throughout the UE 900. In some implementations, some of the memory/storage 906 may be located on the processors 902 themselves (for example, L1 and L2 cache), while other memory/storage 906 is external to the processors 902 but accessible thereto via a memory interface. The memory/storage 906 may include any suitable volatile or non-volatile memory such as, but not limited to, dynamic random-access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 904 may include transceiver circuitry and radio frequency front module (RFEM) that allows the UE 900 to communicate with other devices over a radio access network. The RF interface circuitry 904 may include various elements arranged in transmit or receive paths. These elements may include, for example, switches, mixers, amplifiers, filters, synthesizer circuitry, control circuitry, etc.

In the receive path, the RFEM may receive a radiated signal from an air interface via antenna structure 916 and proceed to filter and amplify (with a low-noise amplifier) the signal. The signal may be provided to a receiver of the transceiver that downconverts the RF signal into a baseband signal that is provided to the baseband processor of the processors 902.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 916.

In various implementations, the RF interface circuitry 904 may be configured to transmit/receive signals in a manner compatible with NR access technologies.

The antenna 916 may include antenna elements to convert electrical signals into radio waves to travel through the air and convert received radio waves into electrical signals. The antenna elements may be arranged into one or more antenna panels. The antenna 916 may have antenna panels that are omnidirectional, directional, or a combination thereof to enable beamforming and multiple input, multiple output communications. The antenna 916 may include microstrip antennas, printed antennas fabricated on the surface of one or more printed circuit boards, patch antennas, phased array antennas, etc. The antenna 916 may have one or more panels designed for specific frequency bands including bands in FRI or FR2.

The user interface 908 includes various input/output (I/O) devices designed to enable user interaction with the UE 900. The user interface 908 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes “LEDs” and multi-character visual outputs), or more complex outputs such as display devices or touchscreens (for example, liquid crystal displays “LCDs,” LED displays, quantum dot displays, projectors, etc.), with the output of characters, graphics, multimedia objects, and the like being generated or produced from the operation of the UE 900.

The sensors 910 may include devices, modules, or subsystems whose purpose is to detect events or changes in their environment and send the information (sensor data) about the detected events to some other device, module, subsystem, etc. Examples of such sensors include, inter alia, inertia measurement units including accelerometers, gyroscopes, or magnetometers; microelectromechanical systems or nanoelectromechanical systems including 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 912 may include software and hardware elements that operate to control particular devices that are embedded in the UE 900, attached to the UE 900, or otherwise communicatively coupled with the UE 900. The driver circuitry 912 may include individual drivers allowing other components to interact with or control various input/output (I/O) devices that may be present within, or connected to, the UE 900. For example, driver circuitry 912 may include a display driver to control and allow access to a display device, a touchscreen driver to control and allow access to a touchscreen interface, sensor drivers to obtain sensor readings of sensors 910 and control and allow access to sensors 910, drivers to obtain actuator positions of electro-mechanic components or control and allow access to the electro-mechanic components, a camera driver to control and allow access to an embedded image capture device, audio drivers to control and allow access to one or more audio devices.

The PMIC 914 may manage power provided to various components of the UE 900. In particular, with respect to the processors 902, the PMIC 914 may control power-source selection, voltage scaling, battery charging, or DC-to-DC conversion.

In some implementations, the PMIC 914 may control, or otherwise be part of, various power saving mechanisms of the UE 900 including DRX as discussed herein. A battery 918 may power the UE 900, although in some examples the UE 900 may be mounted or deployed in a fixed location, and may have a power supply coupled to an electrical grid. The battery 918 may be a lithium-ion battery, a metal-air battery, such as a zinc-air battery, an aluminum-air battery, a lithium-air battery, and the like. In some implementations, such as in vehicle-based applications, the battery 918 may be a typical lead-acid automotive battery.

FIG. 10 is a block diagram of an example access node, according to some implementations. FIG. 10 illustrates an access node 1000 (e.g., a base station or gNB), in accordance with some implementations. The access node 1000 may be similar to and substantially interchangeable with the base station 104 of FIG. 1. The access node 1000 may include processors 1002, RF interface circuitry 1004, core network (CN) interface circuitry 1006, memory/storage circuitry 1008, and antenna structure 1010.

The components of the access node 1000 may be coupled with various other components over one or more interconnects 1012. The processors 1002, RF interface circuitry 1004, memory/storage circuitry 1008 (including communication protocol stack 1014), antenna structure 1010, and interconnects 1012 may be similar to like-named elements shown and described with respect to FIG. 9. For example, the processors 1002 may include processor circuitry such as, for example, baseband processor circuitry (BB) 1016A, central processor unit circuitry (CPU) 1016B, and graphics processor unit circuitry (GPU) 1016C.

The CN interface circuitry 1006 may provide connectivity to a core network, for example, a 5^{th} Generation Core network (5GC) using a 5GC-compatible network interface protocol such as carrier Ethernet protocols, or some other suitable protocol. Network connectivity may be provided to/from the access node 1000 via a fiber optic or wireless backhaul. The CN interface circuitry 1006 may include one or more dedicated processors or FPGAs to communicate using one or more of the aforementioned protocols. In some implementations, the CN interface circuitry 1006 may include multiple controllers to provide connectivity to other networks using the same or different protocols.

As used herein, the terms “access node,” “access point,” or the like may describe equipment that provides the radio baseband functions for data and/or voice connectivity between a network and one or more users. These access nodes can be referred to as BS, gNBs, RAN nodes, eNBs, NodeBs, RSUs, TRxPs or TRPs, and so forth, and can include ground stations (e.g., terrestrial access points) or satellite stations providing coverage within a geographic area (e.g., a cell). As used herein, the term “NG RAN node” or the like may refer to an access node 1000 that operates in an NR or 5G system (for example, a gNB), and the term “E-UTRAN node” or the like may refer to an access node 1000 that operates in an LTE or 4G system (e.g., an eNB). According to various implementations, the access node 1000 may be implemented as one or more of a dedicated physical device such as a macrocell base station, and/or a low power (LP) base station for providing femtocells, picocells or other like cells having smaller coverage areas, smaller user capacity, or higher bandwidth compared to macrocells.

In some implementations, all or parts of the access node 1000 may be implemented as one or more software entities running on server computers as part of a virtual network, which may be referred to as a CRAN and/or a virtual baseband unit pool (vBBUP). In these implementations, the CRAN or vBBUP may implement a RAN function split, such as a PDCP split wherein RRC and PDCP layers are operated by the CRAN/vBBUP and other L2 protocol entities are operated by the access node 1000; a MAC/PHY split wherein RRC, PDCP, RLC, and MAC layers are operated by the CRAN/vBBUP and the PHY layer is operated by the access node 1000; or a “lower PHY” split wherein RRC, PDCP, RLC, MAC layers and upper portions of the PHY layer are operated by the CRAN/vBBUP and lower portions of the PHY layer are operated by the access node 1000.

In V2X scenarios, the access node 1000 may be or act as RSUs. The term “RoadSide Unit” or “RSU” may refer to any transportation infrastructure entity used for V2X communications. An RSU may be implemented in or by a suitable RAN node or a stationary (or relatively stationary) UE, where an RSU implemented in or by a UE may be referred to as a “UE-type RSU,” an RSU implemented in or by an eNB may be referred to as an “eNB-type RSU,” an RSU implemented in or by a gNB may be referred to as a “gNB-type RSU,” and the like.

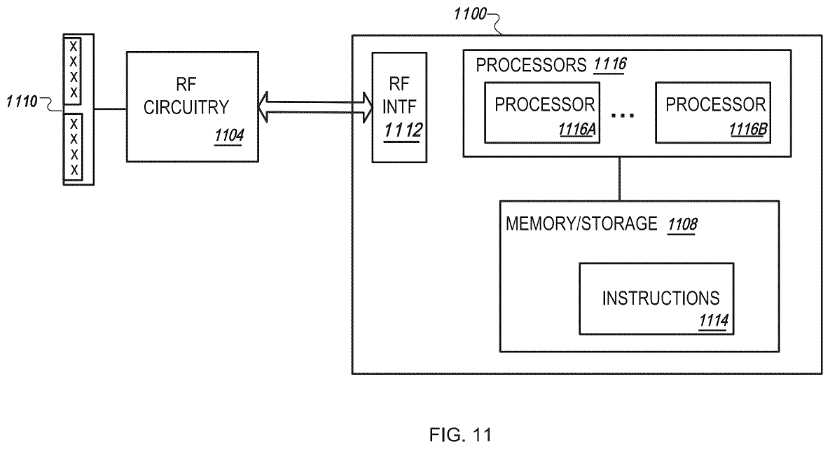

FIG. 11 is a block diagram of an example apparatus 1100, according to some implementations. In some implementations, the apparatus 1100 includes a baseband processor circuitry. For example, the apparatus 1100 may be similar to the baseband processor circuitry (BB) 922A of FIG. 9 or the baseband processor circuitry 1016A of FIG. 10 in some cases.

As shown, the apparatus 1100 includes one or more processors 1116A and 1116B, and memory/storage 1108 storing instructions 1114 that are executed by the one or more processors 1116A and 1116B. Although FIG. 11 illustrates the apparatus 1100 as having multiple processors, in some cases the apparatus 1100 can include a single processor (e.g., one of processor 1116A or processor 1116B).

The apparatus 1100 is electrically and communicatively coupled, through RF interface 1112, to RF circuitry 1104 and associated antenna structure 1110. In some implementations, one or more of the processors 1116A and 1116B execute the instructions 1114 to control communications through the RF interface circuitry 1104 and antenna structure 1110. For example, the one or more processors 1116A and 1116B may execute the instructions 1114 to generate or process baseband signals or waveforms that carry information using wireless channels, and/or manage the radio functions of RF circuitry 1104 and antenna structure 1110, such as signal modulation, encoding, radio frequency shifting, in addition or as an alternative to the user plane or control plane functions as described with respect to the baseband processor circuitry 922A of FIG. 9 and the baseband processor circuitry 1016A of FIG. 10. In doing so, the apparatus 1100 enables communication, e.g., wireless cellular communication, over a 3GPP compatible network.

Additionally, in some implementations, the apparatus 1100 may include wireless hardware connectivity interface(s) to send/receive data to/from Near Field Communication (NFC) components, Bluetooth® components (e.g., Bluetooth® Low Energy), Wi-Fi® components, and other communication components, and a power management interface (e.g., an interface to send/receive power). In such implementations, the instructions 1114 may include instructions that, when executed by one or more of the processors 1116A and 1116B, cause these processors to perform Wi-Fi communications on an 802.11 network, and/or perform Bluetooth communications.

In some implementations, one or more of the processors 1116A and 1116B is a 3G baseband processor, a 4G baseband processor, a 5G baseband processor, or other suitable baseband processor. In some implementations, one or more of the processors 1116A and 1116B may be configured as an FPGA (Field Programmable Gate Array), and/or may have dedicated hardware components, which may include an ASIC (Application Specific Integrated Circuit).

Various components may be described as performing a task or tasks, for convenience in the description. Such descriptions should be interpreted as including the phrase “configured to.” Reciting a component that is configured to perform one or more tasks is expressly intended not to invoke 35 U.S.C. § 112 (f) interpretation for that component.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc., as described above in connection with one or more of the preceding figures may be configured to operate in accordance with one or more of the examples set forth below in the example section.

### EXAMPLES

In the following sections, further exemplary embodiments are provided.

Example 1 includes a method including: receiving, from a base station, a first downlink control information (DCI) indicating a first uplink grant for a first physical uplink shared channel (PUSCH) transmission, wherein the first DCI comprises a redundancy version (RV) corresponding to the first PUSCH transmission; determining whether the RV is self-decodable; and determining whether to transmit a radio resource control (RRC) reconfiguration complete message using the first uplink grant for the first PUSCH transmission, based at least in part on the determination of whether the RV is self-decodable.

Example 2 includes the method of Example 1, wherein determining whether the RV is self-decodable comprises: determining that the RV is self-decodable; and determining to transmit the RRC reconfiguration complete message using the first uplink grant for the first PUSCH transmission.

Example 3 includes the method of Examples 1 or 2, wherein determining whether the RV is self-decodable comprises: determining that the RV is not self-decodable; receiving, from the base station, a second DCI indicating a second uplink grant for a second PUSCH transmission; and transmitting the RRC reconfiguration complete message using the second uplink grant for the second PUSCH transmission.

Example 4 includes the method of Example 3, wherein determining whether the RV is self-decodable further comprises transmitting information different from the RRC reconfiguration complete message using the first uplink grant for the first PUSCH transmission.

Example 5 includes the method of any one of Examples 1-4, further comprising: prior to receiving the first DCI indicating the first uplink grant for the first PUSCH transmission, receiving, from the base station, a DCI indicating an uplink grant for PUSCH transmission; and suspending the PUSCH transmission corresponding to the DCI.

Example 6 includes the method of any one of Examples 1-5, wherein the RRC reconfiguration complete message is generated in response to RRC reconfiguration information for a communications connection received from the base station.

Example 7 includes the method of any one of Examples 1-6, further comprising: terminating a communications connection to the base station; receiving, from a new base station, new RRC reconfiguration information for a new communication connection; receiving, from the new base station, a new DCI indicating a new uplink grant for a new PUSCH transmission; suspending the new PUSCH transmission corresponding to the new DCI; during the suspension, configuring new RRC configuration for the new communications connection based at least on the new RRC reconfiguration information; receiving, from the new base station, a first new DCI indicating a first new uplink grant for a first new PUSCH transmission, wherein the first new DCI comprises a new RV corresponding to the first new PUSCH transmission; determining whether the new RV is self-decodable; and determining whether to transmit a new RRC reconfiguration complete message using the first new uplink grant for the first new PUSCH transmission, based at least in part on the determination of the new RV.

Example 8 includes the method of any one of Examples 1-7, wherein the RV comprises one of RV 1 or RV 2, and the second DCI comprises a second RV and the second RV comprises one of RV 0 or RV 3.

Example 9 includes the method of any one of Examples 1-8, wherein the first DCI comprises a duration between receiving the first DCI and the first PUSCH transmission.

Example 10 includes the method of any one of Examples 1-9, wherein a format of each DCI comprises one of DCI format 0_0 or DCI format 0_1.

Example 11 includes one or more processors of an apparatus, configured to perform the method of any one of Examples 1-10.

Example 12 includes an apparatus comprising: one or more processors; and one or more memory devices storing instructions that, when executed, cause the one or more processors to perform the method of any one of Examples 1-10.

Example 13 includes a method comprising: transmitting, to a user equipment (UE), a first downlink control information (DCI) indicating a first uplink grant for transmission of a first physical uplink shared channel (PUSCH), wherein the first DCI comprises a redundancy version (RV) corresponding to transmission of the first PUSCH; transmitting, to the UE, a second DCI indicating a second uplink grant for transmission of a second PUSCH; in response to transmitting the second DCI, receiving, from the UE, the second PUSCH corresponding to the second DCI, wherein the second PUSCH comprises a RRC reconfiguration complete message generated in response to RRC reconfiguration information for a communications connection, wherein the RRC reconfiguration complete message is included in the second PUSCH based on the UE determining that the RV is not self-decodable.

Example 14 includes the method of Example 13, further comprising: receiving, from the UE, the first PUSCH corresponding to the first DCI, wherein the first PUSCH comprises information different from the RRC reconfiguration complete message.

Example 15 includes the method of Examples 13 or 14, further comprising: prior to transmitting the first DCI indicating the first uplink grant for transmission of the first PUSCH, transmitting, to the UE, a DCI indicating an uplink grant for transmission of a PUSCH; and detecting a failure to decode the PUSCH corresponding to the DCI.

Example 16 includes the method of any one of Examples 13-15, wherein the RV comprises one of RV 1 or RV 2.

Example 17 includes the method of any one of Examples 13-16, wherein the second DCI comprises one of RV 0 or RV 3.

Example 18 includes the method of any one of Examples 13-17, wherein a format of each DCI comprises one of DCI format 0_0 or DCI format 0_1.

Example 19 includes one or more processors of an apparatusconfigured to perform the method of any one of Examples 13-18.

Example 20 includes an apparatus comprising: one or more processors; and one or more memory devices storing instructions that, when executed, cause the one or more processors to perform the method of any one of Examples 13-18.

Various components may be described as performing a task or tasks, for convenience in the description. Such descriptions should be interpreted as including the phrase “configured to.” Reciting a component that is configured to perform one or more tasks is expressly intended not to invoke 35 USC § 112 (f) interpretation for that component.

For one or more implementations, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

Any of the above-described examples may be combined with any other example (or combination of examples), unless explicitly stated otherwise. The foregoing description of one or more implementations provides illustration and description, but is not intended to be exhaustive or to limit the scope of implementations to the precise form disclosed. Modifications and variations are possible in light of the above teachings or may be acquired from practice of various implementations.

Although the implementations above have been described in considerable detail, numerous variations and modifications will become apparent to those skilled in the art once the above disclosure is fully appreciated. It is intended that the following claims be interpreted to embrace all such variations and modifications.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

We claim:

1. A method comprising:
receiving, from a base station, a first downlink control information (DCI) indicating a first uplink grant for a first physical uplink shared channel (PUSCH) transmission, wherein the first DCI comprises a redundancy version (RV) corresponding to the first PUSCH transmission;
determining whether the RV is self-decodable; and
determining whether to transmit a radio resource control (RRC) reconfiguration complete message using the first uplink grant for the first PUSCH transmission, based at least in part on the determination of whether the RV is self-decodable.

2. The method of claim 1, wherein determining whether the RV is self-decodable comprises:
determining that the RV is self-decodable; and
determining to transmit the RRC reconfiguration complete message using the first uplink grant for the first PUSCH transmission.

3. The method of claim 1, wherein determining whether the RV is self-decodable comprises:
determining that the RV is not self-decodable;
receiving, from the base station, a second DCI indicating a second uplink grant for a second PUSCH transmission; and
transmitting the RRC reconfiguration complete message using the second uplink grant for the second PUSCH transmission.

4. The method of claim 3, wherein determining whether the RV is self-decodable further comprises transmitting information different from the RRC reconfiguration complete message using the first uplink grant for the first PUSCH transmission.

5. The method of claim 1, further comprising:
prior to receiving the first DCI indicating the first uplink grant for the first PUSCH transmission, receiving, from the base station, a DCI indicating an uplink grant for PUSCH transmission; and
suspending the PUSCH transmission corresponding to the DCI.

6. The method of claim 1, wherein the RRC reconfiguration complete message is generated in response to RRC reconfiguration information for a communications connection received from the base station.

7. The method of claim 1, further comprising:
terminating a communications connection to the base station;
receiving, from a new base station, new RRC reconfiguration information for a new communication connection;
receiving, from the new base station, a new DCI indicating a new uplink grant for a new PUSCH transmission;
suspending the new PUSCH transmission corresponding to the new DCI;
during the suspension, configuring new RRC configuration for the new communications connection based at least on the new RRC reconfiguration information;
receiving, from the new base station, a first new DCI indicating a first new uplink grant for a first new PUSCH transmission, wherein the first new DCI comprises a new RV corresponding to the first new PUSCH transmission;
determining whether the new RV is self-decodable; and
determining whether to transmit a new RRC reconfiguration complete message using the first new uplink grant for the first new PUSCH transmission, based at least in part on the determination of the new RV.

8. The method of claim 1, wherein the RV comprises one of RV 1 or RV 2, and the second DCI comprises a second RV and the second RV comprises one of RV 0 or RV 3.

9. The method of claim 1, wherein the first DCI comprises a duration between receiving the first DCI and the first PUSCH transmission.

10. The method of claim 1, wherein a format of each DCI comprises one of DCI format 0_0 or DCI format 0_1.

11. One or more processors of an apparatus, configured to perform the method of claim 1.

12. An apparatus comprising:
one or more processors; and
one or more memory devices storing instructions that, when executed, cause the one or more processors to perform the method of claim 1.

13. A method comprising:
transmitting, to a user equipment (UE), a first downlink control information (DCI) indicating a first uplink grant for transmission of a first physical uplink shared channel (PUSCH), wherein the first DCI comprises a redundancy version (RV) corresponding to transmission of the first PUSCH;
transmitting, to the UE, a second DCI indicating a second uplink grant for transmission of a second PUSCH;
in response to transmitting the second DCI, receiving, from the UE, the second PUSCH corresponding to the second DCI, wherein the second PUSCH comprises a RRC reconfiguration complete message generated in response to RRC reconfiguration information for a communications connection, wherein the RRC reconfiguration complete message is included in the second PUSCH based on the UE determining that the RV is not self-decodable.

14. The method of claim 13, further comprising:
receiving, from the UE, the first PUSCH corresponding to the first DCI, wherein the first PUSCH comprises information different from the RRC reconfiguration complete message.

15. The method of claim 13, further comprising:
prior to transmitting the first DCI indicating the first uplink grant for transmission of the first PUSCH, transmitting, to the UE, a DCI indicating an uplink grant for transmission of a PUSCH; and
detecting a failure to decode the PUSCH corresponding to the DCI.

16. The method of claim 13, wherein the RV comprises one of RV 1 or RV 2.

17. The method of claim 13, wherein the second DCI comprises one of RV 0 or RV 3.

18. The method of claim 13, wherein a format of each DCI comprises one of DCI format 0_0 or DCI format 0_1.

19. One or more processors of an apparatus configured to perform the method of claim 13.

20. An apparatus comprising:
one or more processors; and
one or more memory devices storing instructions that, when executed, cause the one or more processors to perform the method of claim 13.
